(19) United States
(12) Patent Application Publication
(10) Pub. No.: US 2008/0117516 A1
(43) Pub. Date: May 22, 2008

(54) Two-layered optical plate and method for making the same

(75) Inventors: Tung-Ming Hsu, Tu-cheng (TW); Shao-Han Chang, Tu-cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI Precision Industry CO., LTD., Tu-Cheng City (TW)

(21) Appl. No.: 11/713,524

(22) Filed: Mar. 2, 2007

(30) Foreign Application Priority Data
Nov. 20, 2006 (CN) 200610201108.2

(51) Int. Cl. G02B 5/02; B29D 11/00

(52) U.S. Cl. 359/599

(57) ABSTRACT

An exemplary optical plate (20) includes a transparent layer (21) and a light diffusion layer (23). The transparent layer includes a light input interface (211), a light output surface (213) opposite to the light input interface, and a plurality of spherical depressions (215) defined at the light output surface. The light diffusion layer is integrally formed with the transparent layer adjacent to the light input interface. The light diffusion layer includes a transparent matrix resins (231) and a plurality of diffusion particles (233) dispersed in the transparent matrix resins. A method for making the optical plate is also provided.

### CROSS-REFERENCE TO RELATED APPLICATIONS

This application is related to two copending U.S. patent applications, application Ser. No. 11/655425 filed on Jan. 19, 2007, entitled “TWO-LAYERED OPTICAL PLATE AND METHOD FOR MAKING THE SAME”, and application Ser. No. [to be advised] (US Docket No. US 11888), filed on [date to be advised], entitled “TWO-LAYERED OPTICAL PLATE AND METHOD FOR MAKING THE SAME”, the inventors with respect to both copending applications being Tung-Ming Hsu and Shao-Han Chang. Both copending applications have the same assignee as the present application. The disclosures of the above identified copending applications are incorporated herein by reference.

### BACKGROUND OF THE INVENTION

1. Field of the Invention

The present invention generally relates to optical plates and methods for making optical plates; and more particularly to an optical plate for use in, for example, a liquid crystal display (LCD).

2. Discussion of the Related Art

The lightness and slimness of LCD panels make them suitable for a wide variety of uses in electronic devices such as personal digital assistants (PDAs), mobile phones, portable personal computers, and other electronic appliances. Liquid crystal is a substance that cannot by itself emit light; instead, the liquid crystal needs to receive light from a light source in order to display images and data. In the case of a typical LCD panel, a backlight module powered by electricity supplies the needed light.

FIG. 13 is an exploded, side cross-sectional view of a typical backlight module 10 employing a typical optical diffusion plate. The backlight module 10 includes a housing 11, a plurality of lamps 12 disposed above a base of the housing 11, and a light diffusion plate 13 and a prism sheet 15 stacked on top of the housing 11 in that order. The lamps 12 emit light rays, and inside walls of the housing 11 are configured for reflecting some of the light rays upwards. The light diffusion plate 13 includes a plurality of embedded dispersion particles. The dispersion particles are configured for scattering received light rays, and thereby enhancing the uniformity of light rays that exit the light diffusion plate 13. The prism sheet 15 includes a plurality of V-shaped structures on a top thereof. The V-shaped structures are configured for collimating received light rays to a certain extent.

In use, the light rays from the lamps 12 enter the prism sheet 15 after being scattered in the diffusion plate 13. The light rays are refracted by the V-shaped structures of the prism sheet 15 and are thereby concentrated so as to increase brightness of light illumination. Finally, the light rays propagate into an LCD panel (not shown) disposed above the prism sheet 15. The brightness may be improved by the V-shaped structures of the prism sheet 15, but the viewing angle may be narrow.

In addition, the diffusion plate 13 and the prism sheet 15 are in contact with each other, but with a plurality of air pockets still existing at the boundary therebetween. When the backlight module 10 is in use, light passes through the air pockets, and some of the light undergoes total reflection at one or another of the corresponding boundaries. As a result, the light energy utilization ratio of the backlight module 10 is reduced.

Therefore, a new optical means is desired in order to overcome the above-described shortcomings. A method for making such optical means is also desired.

### SUMMARY

In one aspect, an optical plate includes a transparent layer and a light diffusion layer. The transparent layer includes a light input interface, a light output surface opposite to the light input interface, and a plurality of spherical depressions defined at the light output surface. The light diffusion layer is integrally formed with the transparent layer adjacent to the light input interface. The light diffusion layer includes a transparent matrix resins and a plurality of diffusion particles dispersed in the transparent matrix resins.

In another aspect, a method for making an optical plate includes the following steps: heating a first transparent matrix resin to a melted state; heating a second transparent matrix resin to a melted state; injecting the melted first transparent matrix resin into a first molding chamber of a two-shot injection mold to form a transparent layer of the at least one optical plate, the two-shot injection mold including a female mold and at least one male mold, the female mold defining at least one molding cavity receiving the at least one male mold, the female mold including a plurality of spherical protruding portions formed at an inmost end of the at least one molding cavity, a portion of the at least one molding cavity and the at least one male mold cooperatively forming the first molding chamber; moving the at least one male mold a distance away from the inmost end of the at least one molding cavity of the female mold; injecting the melted second transparent matrix resin into a second molding chamber of the two-shot injection mold to form a light diffusion layer of the at least one optical plate on the transparent layer, a portion of the at least one molding cavity, the transparent layer, and the at least one male mold cooperatively forming the second molding chamber; and taking the combined transparent layer and light diffusion layer out of the at least one molding cavity of the female mold.

In still another aspect, another method for making an optical plate includes the following steps: heating a first transparent matrix resin to a melted state; heating a second transparent matrix resin to a melted state; injecting the melted first transparent matrix resin into a first molding chamber of a two-shot injection mold to form a light diffusion layer of the optical plate, the two-shot injection mold including a female mold and two male molds, the female mold defining a molding cavity, the molding cavity receiving a first one of the male molds, a portion of the molding cavity and the first male mold cooperatively forming the first molding chamber; withdrawing the first male mold from the female mold; injecting the melted second transparent matrix resin into a second molding chamber of the two-shot injection mold to form a transparent layer of the optical plate on the light diffusion layer, the molding cavity of the female mold receiving the second male mold, the second male mold including a plurality of spherical protruding portions provided at a molding surface thereof, a portion of the molding cavity, the light diffusion layer, and the second male mold cooperatively forming the second molding chamber; and taking the combined light diffusion layer and transparent layer out of the molding cavity of the female mold.

Other novel features and advantages will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate and method. Moreover, in the drawings, like reference numerals designate corresponding parts throughout the several views, and all the views are schematic.

FIG. 1 is an isometric view of an optical plate in accordance with a first embodiment of the present invention.

FIG. 2 is a cross-sectional view taken along line II-II of FIG. 1.

FIG. 3 a graph of relative luminance varying according to viewing angle in respect of a backlight module without an optical plate, the viewing angles being measured in four different planes.

FIG. 4 is a graph of relative luminance varying according to viewing angle in respect of a backlight module having an optical plate in accordance with the first embodiment of the present invention, the viewing angles being measured in four different planes, the four different planes being the same as the four different planes relating to the graph of FIG. 3.

FIG. 5 is a graph of relative luminance varying according to viewing angle in respect of four different backlight modules including among them the backlight module relating to the graph of FIG. 3 and the backlight module relating to the graph of FIG. 4, the viewing angles being measured in a first one of the four different planes relating to the graphs of each of FIG. 3 and FIG. 4.

FIG. 6 is a graph of relative luminance varying according to viewing angle in respect of the four different backlight modules relating to the graph of FIG. 5, the viewing angles being measured in a second one of the four different planes relating to the graphs of each of FIG. 3 and FIG. 4.

FIG. 7 is a side cross-sectional view of an optical plate in accordance with a second embodiment of the present invention.

FIG. 8 is a side cross-sectional view of an optical plate in accordance with a third embodiment of the present invention.

FIG. 9 is a side cross-sectional view of an optical plate in accordance with a fourth embodiment of the present invention.

FIG. 10 is a side cross-sectional view of a two-shot injection mold used in an exemplary method for making the optical plate of FIG. 1, showing formation of a transparent layer of the optical plate.

FIG. 11 is similar to FIG. 10, but showing subsequent formation of a diffusion layer of the optical plate on the transparent layer, and showing simultaneous formation of a transparent layer of a second optical plate.

FIG. 12 is a side, cross-sectional view of another two-shot injection mold used in another exemplary method for making the optical plate of FIG. 1.

FIG. 13 is an exploded, side cross-sectional view of a conventional backlight module.

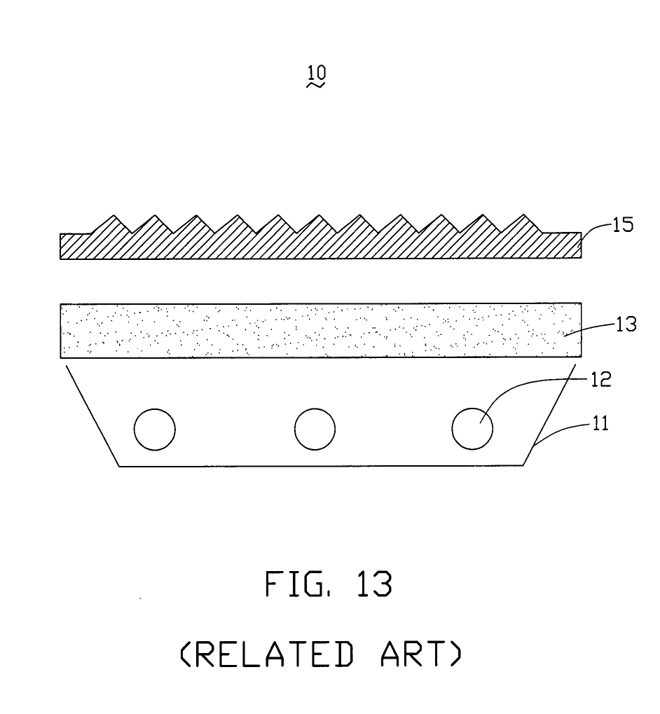

### DETAILED DESCRIPTION OF THE EMBODIMENTS

Reference will now be made to the drawings to describe preferred embodiments of the present optical plate and method for making the optical plate, in detail.

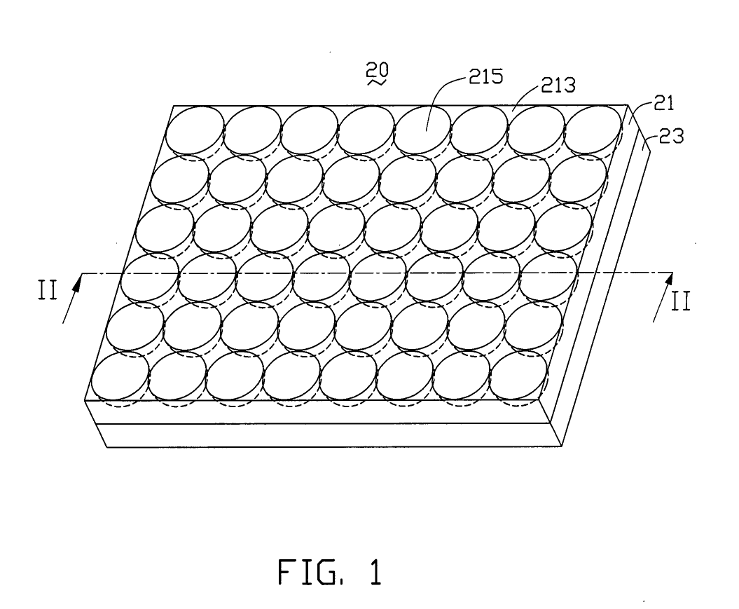

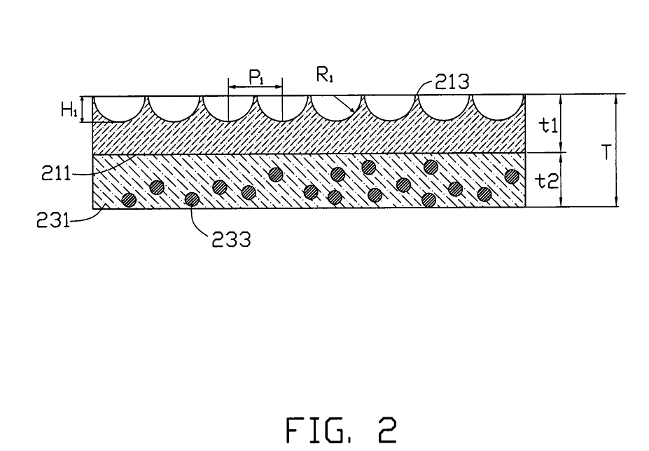

Referring now to FIGS. 1-2, these show an optical plate 20 according to a first embodiment. The optical plate 20 includes a transparent layer 21 and a light diffusion layer 23. The transparent layer 21 and light diffusion layer 23 are integrally formed. That is, the transparent layer 21 and light diffusion layer 23 are in immediate contact with each other at a common interface thereof. The transparent layer 21 includes a light input interface 211, a light output surface 213 opposite to the light input interface 211, and a plurality of spherical depressions 215 defined at the light output surface 213. The light diffusion layer 23 is located adjacent the light input interface 211. The spherical depressions 215 are configured for collimating light rays emitting from the optical plate 20, and thereby improving the brightness of light illumination.

A thickness t1 of the transparent layer 21 and a thickness t2 of the light diffusion layer 23 can each be equal to or greater than 0.35 millimeters. In the illustrated embodiment, a total value T of the thicknesses t1 and t2 can be in the range from 1 millimeter to 6 millimeters. The transparent layer 21 can be made of one or more transparent matrix resins selected from the group including polyacrylic acid (PAA), polycarbonate (PC), polystyrene (PS), polymethyl methacrylate (PMMA), polyurethane, methylmethacrylate and styrene (MS), and so on. The light input interface 211 of the transparent layer 21 can be either smooth or rough.

In the illustrated embodiment, each spherical depression 215 is substantially a hemisphere. In alternative embodiments, each spherical depression 215 can instead be smaller than a hemisphere. That is, each spherical depression 215 can instead be a sub-hemisphere. The spherical depressions 215 are arranged regularly on the light output surface 213 in a matrix. In order to obtain a good optical effect, a radius R₁ of each spherical depression 215 is preferably in the range from about 0.01 millimeters to about 3 millimeters. A depth H₁ of the spherical depressions 215 can be in the range from about 0.01 millimeters to the radius R₁. A pitch P₁ between centers of two adjacent spherical depressions 215 can be in the range from about 0.0025 millimeters to about 12 millimeters. In the illustrated embodiment, the depth H₁ is equal to the radius R₁, and the pitch P₁ is greater than 2R₁.

The light diffusion layer 23 has a light transmission ratio in the range from 30% to 98%. The diffusion layer 23 is configured for enhancing optical uniformity. The light diffusion layer 23 includes a transparent matrix resin 231, and a plurality of diffusion particles 233 dispersed in the transparent matrix resin 231. The transparent matrix resin 231 can be one or more transparent matrix resins selected from the group including polyacrylic acid (PAA), polycarbonate (PC), polystyrene, polymethyl methacrylate (PMMA), polyurethane, methylmethacrylate and styrene (MS), and any suitable combination thereof. The diffusion particles 233 can be made of material selected from the group including titanium dioxide, silicon dioxide, acrylic resin, and any combination thereof. The diffusion particles 233 are configured for scattering light rays and enhancing the light distribution capability of the light diffusion layer 23.

When the optical plate 20 is utilized in a typical backlight module, light rays from lamp tubes (not shown) of the backlight module enter the light diffusion layer 23 of the optical plate 20. The light rays are substantially diffused in the light diffusion layer 23. Subsequently, many or most of the light rays are condensed by the spherical depressions 215 of the transparent layer 21 before they exit the light output surface 213. As a result, a brightness of light provided by the backlight module is increased. In addition, the transparent layer 21 and the light diffusion layer 23 are integrally formed together, with no air or gas pockets trapped therebetween. This reduces or even eliminates back reflection, and thereby increases the efficiency of utilization of light rays.

When the optical plate 20 is utilized in the backlight module, it can replace the conventional combination of a diffusion plate and a prism sheet. Thereby, the process of assembly of the backlight module is simplified. In addition, the volume occupied by the optical plate 20 is generally less than that occupied by the combination of a diffusion plate and a prism sheet. Thereby, the volume of the backlight module is reduced. Furthermore, the single optical plate 20 instead of the combination of two optical plates/sheets can save on costs.

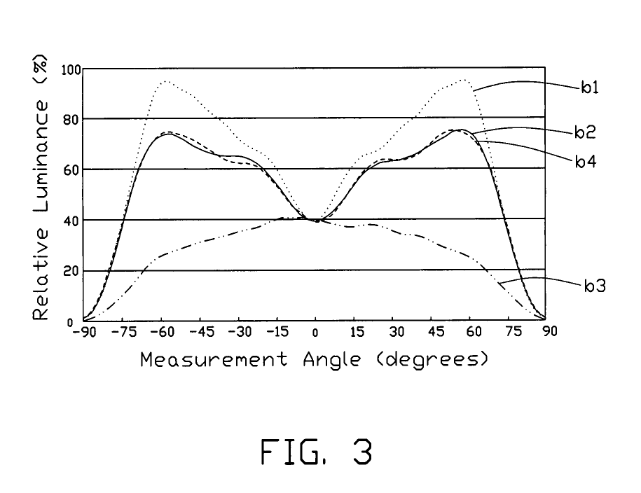

Optical characteristics of the optical plate 20 have been tested, and corresponding data in respect of four different backlight modules is shown in Table 1 below. The results are illustrated in FIGS. 3-7. In the testing process, a housing (not shown) and a plurality of lamp tubes (not shown) were provided for testing the four sample backlight modules. The four backlight modules included one control backlight module (no optical plate), one backlight module with a conventional light diffusing plate, one backlight module with a conventional prism sheet, and one backlight module configured with the optical plate 20.

TABLE 1

| Sample no. | Sample description |
|---|---|
| a0 | backlight module without an optical plate |
| a1 | backlight module with a conventional light diffusing plate |
| a2 | backlight module with a conventional prism sheet |
| a3 | backlight module with the present optical plate of the first |
| | embodiment |

According to the tests, a backlight module is assumed to provide a vertically oriented planar light source. A center axis of the planar light source that lies in the plane and is horizontal is defined as a horizontal axis. A center axis of the planar light source that lies in the plane and is vertical is defined as a vertical axis. The horizontal axis and the vertical axis intersect at an origin. Four ranges of viewing angles are defined. Each range of viewing angles is from −90° to 90° (a total span of 180°), measured at the origin. Each range of viewing angles occupies a plane that is perpendicular to the planar light source. A first range of viewing angles occupies a plane that coincides with the vertical axis. A second range of viewing angles occupies a plane that is oriented 45° away from the first range of viewing angles in a first direction. A third range of viewing angles occupies a plane that coincides with the horizontal axis. A fourth range of viewing angles occupies a plane that is oriented 135° away from the first range of viewing angles in the first direction.

FIG. 3 is a graph illustrating curves of viewing angle characteristics of the sample a0. Curves b1, b2, b3, and b4 represent viewing angle characteristics tested along the first through fourth ranges of viewing angles as defined above, respectively.

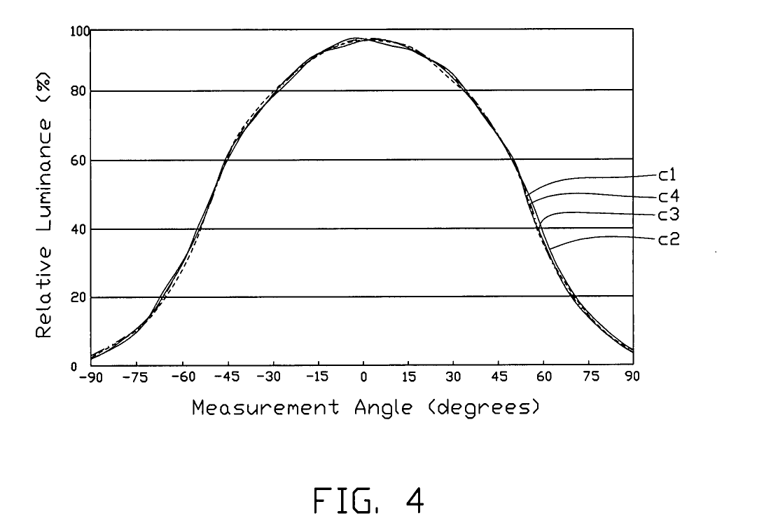

FIG. 4 is a graph illustrating curves of viewing angle characteristics of the sample a3. Curves c1, c2, c3, and c4 represent viewing angle characteristics tested along the same first through fourth ranges of viewing angles as defined above, respectively.

In FIGS. 3 and 4, it can be seen that the four curves b1, b2, b3, and b4 are substantially different from each other, whereas the four curves c1, c2, c3, and c4 are substantially similar to each other. It can be concluded that the optical plate 20 greatly improves the uniformity of light output by the backlight module.

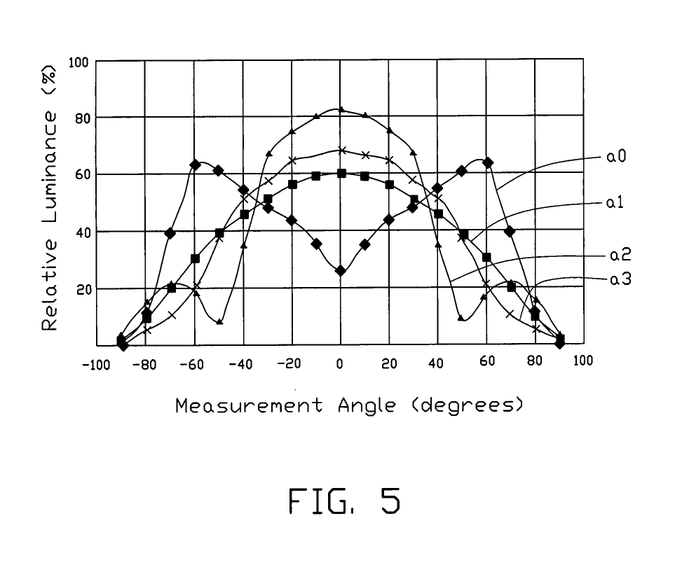

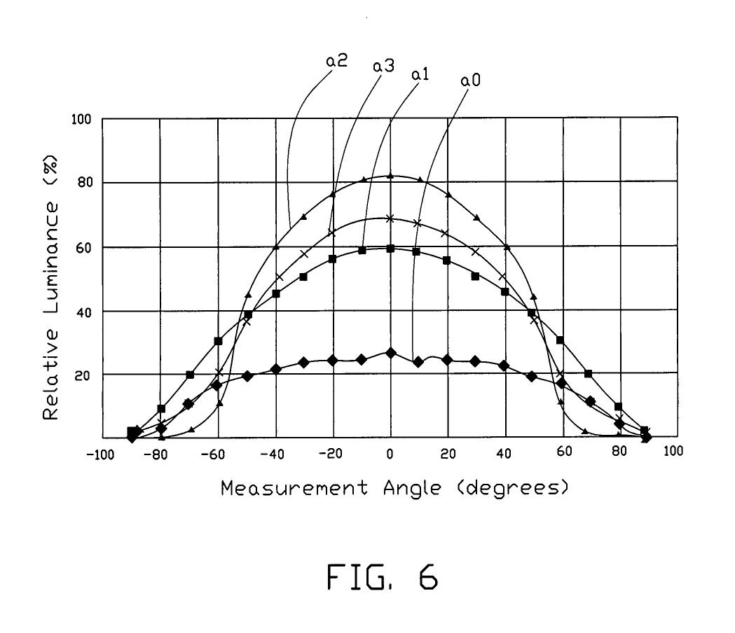

FIG. 5 is a graph illustrating curves of viewing angle characteristics of the samples a0, a1, a2, and a3 measured in the first range of viewing angles. FIG. 6 is a graph illustrating curves of viewing angle characteristics of the samples a0, a1, a2, and a3 measured in the third range of viewing angles. It can be seen that in both ranges of viewing angles, the sample a3 has a higher brightness in a range from −45 degrees to 45 degrees than the sample a1. That is, the sample a3 has a higher brightness in the middle. It can also be seen that in both ranges of viewing angles, an attenuation of brightness of the sample a3 in a range from 40 degrees to 60 degrees (and similarly in a range from −60 degrees to −40 degrees) changes more gradually than that of the sample a2. Therefore the sample a3 can provide a broader range of angles of viewing (i.e., viewing angle).

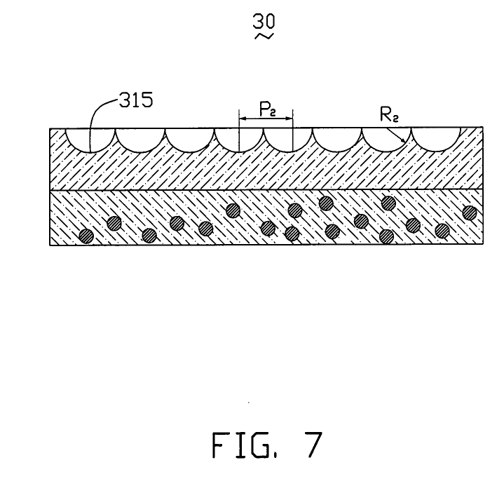

Referring to FIG. 7, an optical plate 30 according to a second embodiment is shown. The optical plate 30 is similar in principle to the optical plate 20 described above. However, in the optical plate 30, a pitch P₂ between centers of two adjacent spherical depressions 315 is 2R₂, wherein R₂ represents a radius of each spherical depression 315.

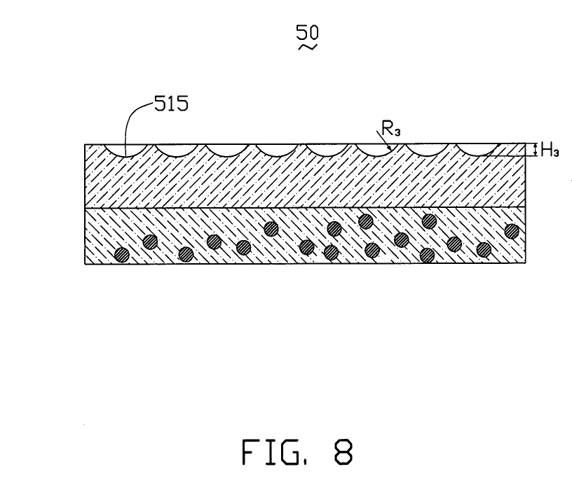

Referring to FIG. 8, an optical plate 50 according to a third embodiment is shown. The optical plate 50 is similar in principle to the optical plate 20 described above. However, the optical plate 50 defines a plurality of spherical depressions 515 at a light output surface (not labeled). A depth H₃ of each spherical depression 515 is 0.5R₃, wherein R₃ represents a radius of each spherical depression 515.

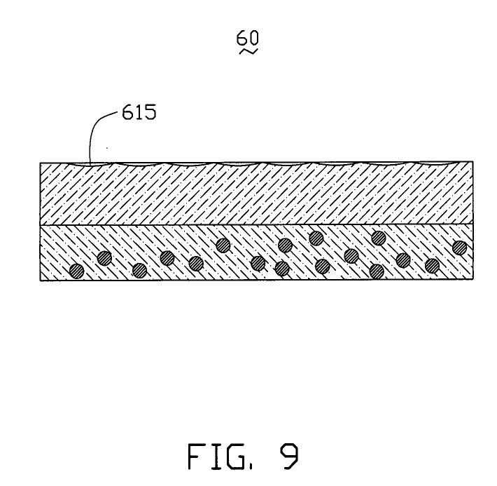

Referring to FIG. 9, an optical plate 60 according to a fourth embodiment is shown. The optical plate 60 is similar in principle to the optical plate 20 described above. However, the optical plate 60 defines a plurality of spherical depressions 615 at a light output surface (not labeled). Each spherical depression 615 is part of a hemisphere, and a depth of each spherical depression 615 is approximately 0.01 millimeters.

In alternative embodiments, the spherical depressions are not limited to being arranged regularly in a matrix. The spherical depressions can instead be arranged otherwise. For example, the spherical depressions can be arranged in rows, with the spherical depressions in each row being staggered relative to the spherical depressions in each of the two adjacent rows. In another example, the spherical depressions can also be arranged randomly at the light output surface. In any one optical plate, the spherical depressions can have different sizes and/or shapes. For example, a radius of a particular group of the spherical depressions can be larger than a radius of all the other spherical depressions.

An exemplary method for making the optical plate 20 will now be described. In this method, the optical plate 20 is made using a two-shot injection technique.

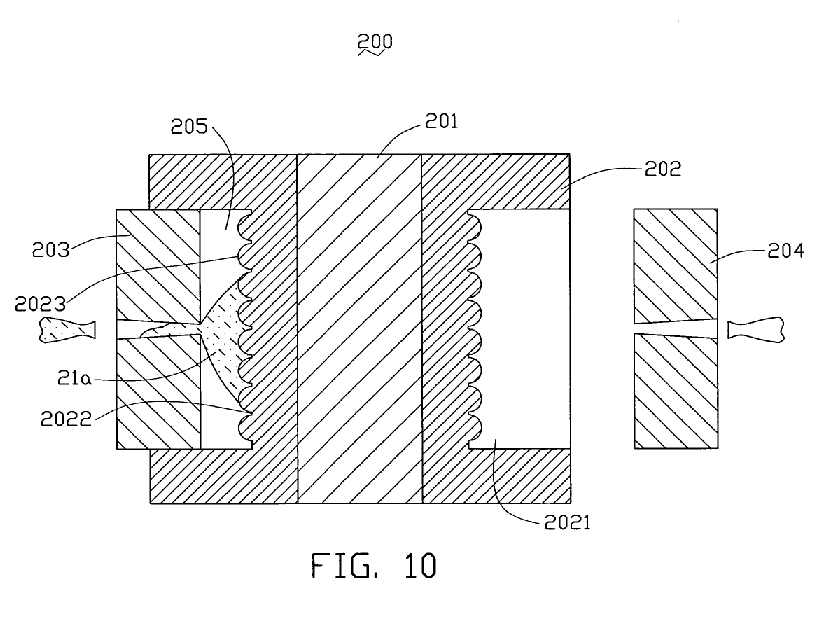

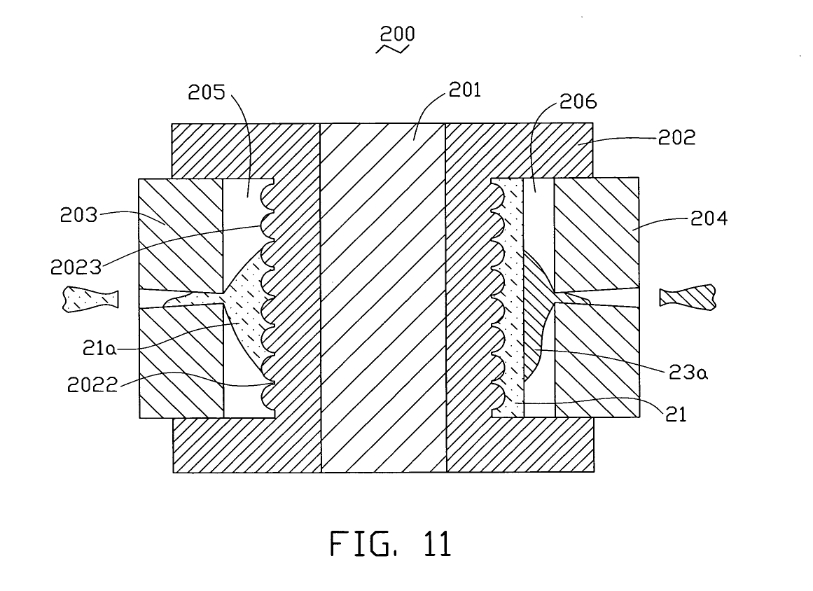

Referring to FIGS. 10-11, a two-shot injection mold 200 is provided for making the optical plate 20. The two-shot injection mold 200 includes a rotating device 201, a first mold 202 functioning as two female molds, a second mold 203 functioning as a first male mold, and a third mold 204 functioning as a second male mold. The first mold 202 defines two molding cavities 2021, and includes an inmost surface 2022 at an inmost end of each of the molding cavities 2021. A plurality of spherical protruding portions 2023 is provided at each of the inmost surfaces 2022. Each of the spherical protruding portions 2023 has a shape corresponding to that of each of the spherical depressions 215 of the optical plate 20.

In a molding process, a first transparent matrix resin 21a is melted. The first transparent matrix resin 21a is for making the transparent layer 21. A first one of the molding cavities 2021 of the first mold 202 slidingly receives the second mold 203, so as to form a first molding chamber 205 for molding the first transparent matrix resin 21a. Then, the melted first transparent matrix resin 21a is injected into the first molding chamber 205. After the transparent layer 21 is formed, the second mold 203 is withdrawn from the first molding cavity 2021. The first mold 202 is rotated about 180° in a first direction. A second transparent matrix resin 23a is melted. The second transparent matrix resin 23a is for making the light diffusion layer 23. The first molding cavity 2021 of the first mold 202 slidingly receives the third mold 204, so as to form a second molding chamber 206 for molding the second transparent matrix resin 23a. Then, the melted second transparent matrix resin 23a is injected into the second molding chamber 206. After the light diffusion layer 23 is formed, the third mold 204 is withdrawn from the first molding cavity 2021. The first mold 202 is rotated further in the first direction, for example about 90 degrees, and the solidified combination of the transparent layer 21 and the light diffusion layer 23 is removed from the first molding cavity 2021. In this way, the optical plate 20 is formed using the two-shot injection mold 200.

As shown in FIG. 11, when the light diffusion layer 23 is being formed in the first molding cavity 2021, simultaneously, a transparent layer 21 for a second optical plate 20 can be formed in the second one of the molding cavities 2021. Once the first optical plate 20 is removed from the first molding cavity 2021, the first mold 202 is rotated still further in the first direction about 90 degrees back to its original position. Then the first molding cavity 2021 slidingly receives the second mold 203 again, and a third optical plate 20 can begin to be made in the first molding chamber 205. Likewise, the second molding cavity 2021 having the transparent layer 21 for the second optical plate 20 slidingly receives the third mold 204, and a light diffusion layer 23 for the second optical plate 20 can begin to be made in the second molding chamber 206.

In an alternative embodiment of the above-described molding process(es), after the third mold 204 is withdrawn from the first molding cavity 2021, the first mold 202 can be rotated in a second direction opposite to the first direction. For example, the first mold 202 can be rotated about 90 degrees in the second direction. Then the solidified combination of the transparent layer 21 and the light diffusion layer 23 is removed from the first molding cavity 2021, such solidified combination being the first optical plate 20. Once the first optical plate 20 has been removed from the first molding cavity 2021, the first mold 202 is rotated further in the second direction about 90 degrees back to its original position.

The transparent layer 21 and light diffusion layer 23 of each optical plate 20 are integrally formed by the two-shot injection mold 200. Therefore no air or gas is trapped between the transparent layer 21 and light diffusion layer 23. Thus the interface between the two layers 21, 23 provides for maximum unimpeded passage of light therethrough.

It should be understood that the first optical plate 20 can be formed using only one female mold, such as that of the first mold 202 at the first molding cavity 2021 or the second molding cavity 2021, and one male mold, such as the second mold 203 or the third mold 204. For example, a female mold such as that of the first molding cavity 2021 can be used with a male mold such as the second mold 203. In this kind of embodiment, the transparent layer 21 is first formed in a first molding chamber cooperatively formed by the male mold moved to a first position and the female mold. Then the male mold is separated from the transparent layer 21 and moved a short distance to a second position. Thus a second molding chamber is cooperatively formed by the male mold, the female mold, and the transparent layer 21. Then the light diffusion layer 23 is formed on the transparent layer 21 in the second molding chamber.

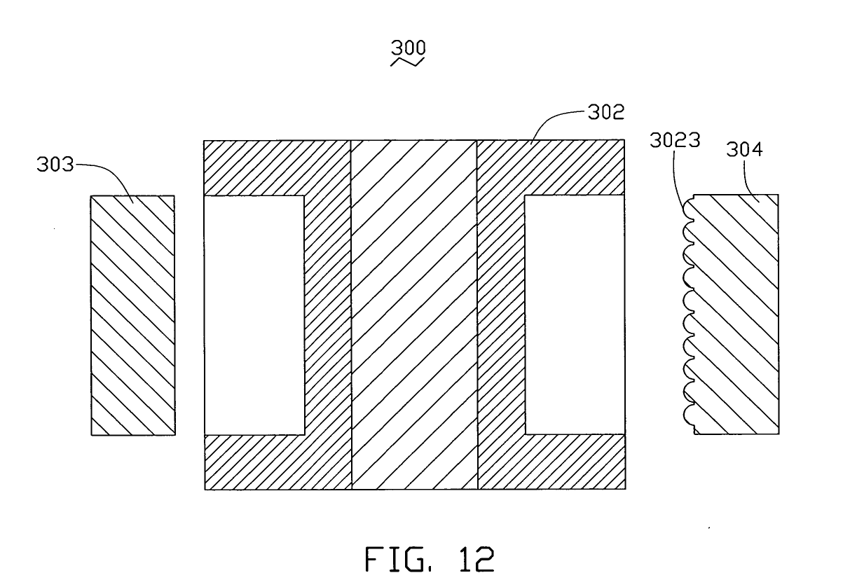

Referring to FIG. 12, in an alternative exemplary method for making the optical plate 20, a two-shot injection mold 300 is provided. The two-shot injection mold 300 is similar in principle to the two-shot injection mold 200 described above, except that a plurality of spherical protruding portions 3023 are provided on a molding surface of a third mold 304. The third mold 304 functions as a second male mold. Each of the spherical protruding portions 3023 has a shape corresponding to that of each of the spherical depressions 215 of the optical plate 20. In the method for making the optical plate 20 using the two-shot injection mold 300, firstly, a melted first transparent matrix resin is injected into a first molding chamber formed by a first mold 302 and a second mold 303, so as to form the light diffusion layer 23. Then, the first mold 302 is rotated 180° in a first direction. The first mold 302 slidably receives the third mold 304, so as to form a second molding chamber. A melted second transparent matrix resin is injected into the second molding chamber, so as to form the transparent layer 21 on the light diffusion layer 23.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical plate, comprising:
a transparent layer including a light input interface, a light output surface opposite to the light input interface, and a plurality of spherical depressions defined at the light output surface; and
a light diffusion layer integrally formed in immediate contact with the light input interface of the transparent layer, the light diffusion layer including a transparent matrix resin and a plurality of diffusion particles dispersed in the transparent matrix resin.

2. The optical plate as claimed in claim 1, wherein a thickness of the transparent layer and a thickness of the light diffusion layer are each greater than 0.35 millimeters.

3. The optical plate as claimed in claim 1, wherein the transparent matrix resin is at least one item selected from the group consisting of polyacrylic acid, polycarbonate, polystyrene, polymethyl methacrylate, polyurethane, methylmethacrylate and styrene, and any combination thereof.

4. The optical plate as claimed in claim 1, wherein the diffusion particles are made of one or more materials selected from the group consisting of titanium dioxide, silicon dioxide, acrylic resin, and any combination thereof.

5. The optical plate as claimed in claim 1, wherein the spherical depressions are arranged regularly at the light output surface in a matrix.

6. The optical plate as claimed in claim 1, wherein a radius of each spherical depression is in the range from about 0.01 millimeters to about 3 millimeters.

7. The optical plate as claimed in claim 1, wherein a pitch between each two adjacent spherical depressions is in the range from about 0.0025 millimeters to about 12 millimeters.

8. The optical plate as claimed in claim 1, wherein a depth of each spherical depression is equal to a radius of each spherical depression.

9. The optical plate as claimed in claim 1, wherein a pitch between each two adjacent spherical depressions is twice a radius of each spherical depression.

10. The optical plate as claimed in claim 1, wherein a radius of each spherical depression is about twice a depth of each spherical depression.

11. The optical plate as claimed in claim 1, wherein a depth of each spherical depression is about 0.01 millimeters.

12. A method for making at least one optical plate, comprising:
heating a first transparent matrix resin to a melted state;
heating a second transparent matrix resin to a melted state;
injecting the melted first transparent matrix resin into a first molding chamber of a two-shot injection mold to form a transparent layer of the at least one optical plate, the two-shot injection mold including a female mold and at least one male mold, the female mold defining at least one molding cavity receiving the at least one male mold, the female mold including a plurality of spherical protruding portions formed at an inmost end of the at least one molding cavity, a portion of the at least one molding cavity and the at least one male mold cooperatively forming the first molding chamber;
moving the at least one male mold a distance away from the inmost end of the at least one molding cavity of the female mold;
injecting the melted second transparent matrix resin into a second molding chamber of the two-shot injection mold to form a light diffusion layer of the at least one optical plate on the transparent layer, a portion of the at least one molding cavity, the transparent layer, and the at least one male mold cooperatively forming the second molding chamber; and
taking the combined transparent layer and light diffusion layer out of the at least one molding cavity of the female mold.

13. The method for making at least one optical plate as claimed in claim 12, wherein the second transparent matrix resin includes a plurality of diffusion particles dispersed therein.

14. The method for making at least one optical plate as claimed in claim 13, wherein the second transparent matrix resin comprises at least one item selected from the group consisting of polyacrylic acid, polycarbonate, polystyrene, polymethyl methacrylate, polyurethane, methylmethacrylate and styrene, and any combination thereof, and the diffusion particles are made of material selected from the group consisting of titanium dioxide, silicon dioxide, acrylic resin, and any combination thereof.

15. The method for making at least one optical plate as claimed in claim 12, wherein the two-shot injection mold further comprises a rotating device, the at least one male mold is two male molds, the at least one molding cavity is two molding cavities, a first one of the molding cavities receives a first one of the male molds to define the first molding chamber, and after the melted first transparent matrix resin is injected into the first molding chamber, the first male mold is withdrawn from the first molding cavity of the female mold, and the female mold is rotated, and after the female mold is rotated, the first molding cavity receives the second male mold to define the second molding chamber, and the second molding cavity receives the first male mold to define the first molding chamber in order to form a transparent layer for another one of the at least one optical plate.

16. A method for making an optical plate, comprising:
heating a first transparent matrix resin to a melted state;
heating a second transparent matrix resin to a melted state;
injecting the melted first transparent matrix resin into a first molding chamber of a two-shot injection mold to form a light diffusion layer of the optical plate, the two-shot injection mold including a female mold and two male molds, the female mold defining a molding cavity, the molding cavity receiving a first one of the male molds, a portion of the molding cavity and the first male mold cooperatively forming the first molding chamber;
withdrawing the first male mold from the female mold;
injecting the melted second transparent matrix resin into a second molding chamber of the two-shot injection mold to form a transparent layer of the optical plate on the light diffusion layer, the molding cavity of the female mold receiving the second male mold, the second male mold including a plurality of spherical protruding portions provided at a molding surface thereof, a portion of the molding cavity, the light diffusion layer, and the second male mold cooperatively forming the second molding chamber; and
taking the combined light diffusion layer and transparent layer out of the molding cavity of the female mold.

17. The method for making an optical plate as claimed in claim 16, wherein the first transparent matrix resin includes a plurality of diffusion particles dispersed therein.

18. The method for making an optical plate as claimed in claim 17, wherein the first transparent matrix resin is at least one item selected from the group consisting of polyacrylic acid, polycarbonate, polystyrene, polymethyl methacrylate, polyurethane, methylmethacrylate and styrene, and any combination thereof, and the diffusion particles are made of material selected from the group consisting of titanium dioxide, silicon dioxide, acrylic resin, and any combination thereof.
